(19) United States
(12) Patent Application Publication
(10) Pub. No.: US 2026/0023868 A1
(43) Pub. Date: Jan. 22, 2026

(54) SECURE TRANSACTIONS WITH AMBIENT WIRELESS DEVICES OVER THE INTERNET

(71) Applicant: Cypress Semiconductor Corporation, San Jose, CA (US)

(72) Inventors: Hui Luo, Marlboro, NJ (US); Rakesh Taori, McKinney, TX (US)

(73) Assignee: Cypress Semiconductor Corporation, San Jose, CA (US)

(21) Appl. No.: 18/780,286

(22) Filed: Jul. 22, 2024

(51) Int. Cl. G06F 21/62; H04W 12/06

(52) U.S. Cl. CPC G06F 21/6218; H04W 12/06

(57) ABSTRACT

A system and method of secure transactions with ambient wireless devices. The method includes receiving, from a user device via a first communication protocol, a request for data associated with a second device. The method includes determining, based on the request, a capability of a first device to access the data from the second device via a second communication. The method includes sending, by one or more processors to the first device via the first communication protocol, a message to cause the first device to access the data from the second device using a second communication protocol and send the data to the processing device using the first communication protocol. The method includes granting or denying the user device with access to the data.

### TECHNICAL FIELD

The present disclosure relates generally to the field of electronics, and more particularly, to systems and methods of performing secure transactions with ambient wireless devices over the internet.

### BACKGROUND

Ambient Internet of Things (IOT) refers to an ecosystem of a large number of objects in which every item is connected into a wireless sensor network using low-cost self-powered sensor nodes. Bluetooth SIG has assessed the total addressable market of Ambient IoT to be more than 10 trillion devices across different verticals. The applications of Ambient IoT include making supply chains for food and medicine more efficient and sustainable, protecting from counterfeiting and delivering the data required for advanced transportation and smart city initiatives.

### BRIEF DESCRIPTION OF THE DRAWINGS

The present disclosure is illustrated by way of example, and not by way of limitation, in the figures of the accompanying drawings in which like reference numerals refer to similar elements and in which:

FIG. 1 illustrates a block diagram of an example ambient device management (ADM) system that uses a particular type of communication protocol to perform remote transactions with an ambient device that does not support the particular type of communication protocol, according to some embodiments.

FIG. 2 illustrates a flowchart for populating a data store with mapping data that indicates an association between ADM servers, reading devices, and ambient devices and to be used for performing remote transactions with the ambient devices, according to some embodiments;

FIG. 3 illustrates a flowchart for the ADM system 101 in FIG. 1 where reading devices initiate Secure Transaction Links (STLs) with ambient devices;

FIG. 4 illustrates a flowchart for the ADM system 101 in FIG. 1 where ambient device initiate STLs with reading devices, according to some embodiments; and

FIG. 5 is a flow diagram of a procedure for performing remote transactions using multiple types of radio frequency (RF) communication protocols, according to some embodiments.

### DETAILED DESCRIPTION

The following description sets forth numerous specific details such as examples of specific systems, components, methods, and so forth, in order to provide a good understanding of various embodiments of the techniques described herein for performing secure transactions with ambient wireless devices over the internet. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Conventional methods to access ambient devices (e.g., a Radio Frequency (RF) tag) using secure transaction communication can only happen in short ranges between a reading device and an ambient device. These conventional method emphasize minimum message exchanges with ambient devices in order to save power for the ambient device. However, these conventional methods and ambient devices do not support a layered networking model, thus these ambient devices cannot be used in existing Transmission Control Protocol/Internet Protocol (TCP/IP) based remote access model. Thus, there is a long felt need for a mechanism to access the data generated by an ambient device over long ranges, e.g., over the internet.

Aspects of the disclosure address the above-noted and other deficiencies by performing secure transactions with ambient wireless devices over the internet.

In an illustrative embodiment, an ADM server receives, from a user device (e.g., a smart phone) via a first type of communication protocol (e.g., Transmission control Protocol/Internet Protocol (TCP/IP)), a request for data associated with an ambient device. The ADM server determines, based on the request, a capability of a reading device (e.g., a special set top box in proximity of a plural number of ambient devices) to access the data from the ambient device via a second type of communication (e.g., near field communication). The ADM server sends, to the reading device via the first type of communication protocol, a message to cause the reading device to access the data from the ambient device using a second type of communication protocol and send the data to the ADM server using the first type of communication protocol. The ADM server grants or denies the user device with access to the data.

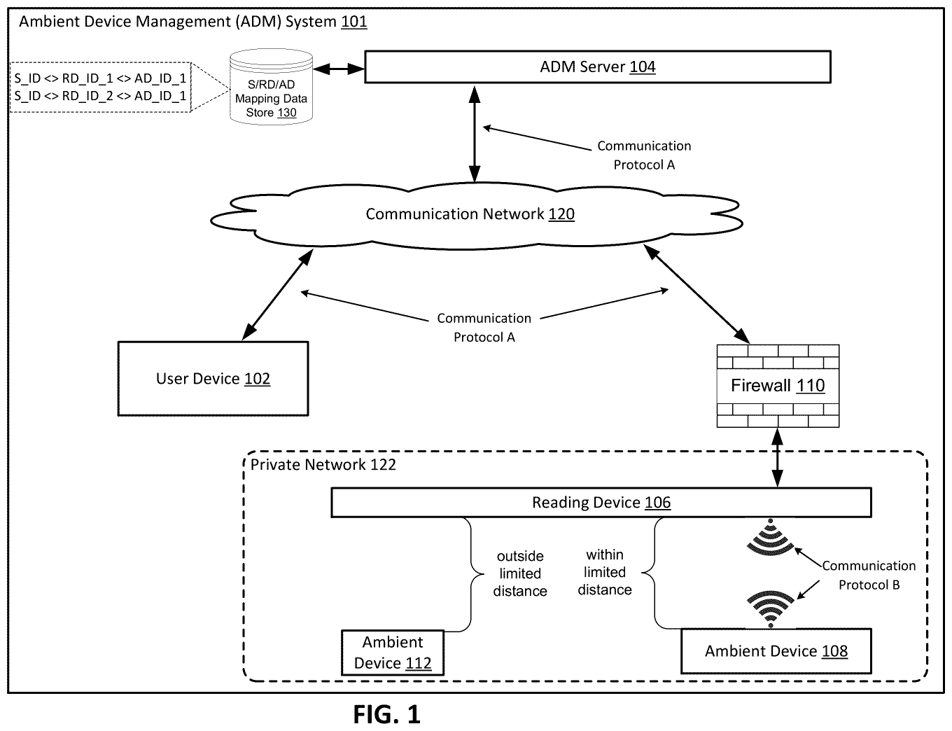

FIG. 1 illustrates a block diagram of an example ambient device management (ADM) system that uses a particular type of communication protocol to perform remote transactions with an ambient device that does not support the particular type of communication protocol, according to some embodiments. The ADM system 101 includes a user device 102, an ADM server 104 (e.g., a single server or a collection of servers or host machines that form a cloud system), and a firewall 110 that are each communicatively coupled together to a communication network 120 via a first type of communication protocol (shown in FIG. 1 as communication protocol A).

The firewall 110 is communicatively coupled to a reading device 106 via the first type of communication protocol, where the reading device 106 is included in a private network 122. The firewall 110 creates the private network 112 by requiring all communication between the reading device 106 and devices (e.g., user device 102, ADM server 104) on the communication network 120 to pass through the firewall 110 so that the firewall 110 can provide a layer of security to block any malicious attacks and/or unprivileged access attempts from entering into the private network 122.

The private network 112 also includes an ambient device 108 that is physically positioned within a limited distance from the reading device 106 to allow the ambient device 108 to communicate with the reading device 106 via a second type of communication protocol (shown in FIG. 1 as communication protocol B).

Although not shown in FIG. 1, the private network 122 may include more than one ambient device 108 and/or more than one reading device 106. As such, each ambient device 108 may be within the limited distance to communicate with a first group of the reading devices 106 and/or outside the limited distance to communicate with a second group of the reading devices 106. The private network 112 also includes an ambient device 108 that is physically positioned outside of the limited distance from the reading device 106, thereby preventing the ambient device 108 from being able to communicate with the reading device 106 via the second type of communication protocol.

The user device 102 may be any type of a device that has the capability (e.g., hardware, software, etc.) to communicate across the communication network 120. For example, the user device 102 may be a smart phone, a laptop, a desktop, a game console, a set-top box (STB), a cloud device (e.g., a host machine), test equipment, and/or the like. The ADM system 101 and/or an administrator of the ADM system 101 assigns a device identifier (e.g., Media Access Control (MAC) to the user device 102 so that the user device 102 is uniquely identifiable from other devices. The ADM system 101 and/or an administrator of the ADM system 101 also assigns a network address (e.g., IP address) to the user device 102, which allows the user device 102 to communicate with other devices that are communicatively coupled to the communication network 120 and by using a first type of communication protocol (e.g., Wi-Fi, cellular, etc.) that is associated with the communication network 120. The ADM system 101 uses the first type of communication protocol to establish a secure connection (e.g., Transport Layer Security (TLS)) with the reading device 106 and the user device 102.

The ADM system 101 and/or an administrator of the ADM system 101 assigns a device identifier to the ambient device 108 so that the ambient device 108 is uniquely identifiable from other devices. However, the ADM system 101 and/or administrator of the ADM system 101 never assigns a network address (e.g., Internet Protocol (IP) address) to the ambient device 108 because the ambient device 108 lacks the capability to communicate over the communication network 120 using the first type of communication protocol that is associated with the communication network 120. For example, an ambient device 108 may lack a capability to communicate over the communication network 120 because the ambient device 108 is missing hardware components, software components, and/or sufficient power to communicate with the communication network 120 using the first type of communication protocol. Instead, the ambient device 108 is only equipped with the appropriate hardware (e.g., a transponder) and/or software components (e.g., a software stack) to communicate with the reading device 106 using a second type of communication protocol (e.g., near field communication (NFC)).

For example, the ambient device 108 may be a Radio Frequency Identification (RFID) tag that uses NFC, which is a communication protocol that allows the ambient device 108 to communicate with another device (e.g., reading device 106) so long that the two devices are physically proximate (e.g., within 10 centimeters or less) to each other. As another example, the ambient device 108 may be a low-power, low-bit rate Wi-Fi and/or Bluetooth (BT) device whose second type of communication protocol is Wi-Fi or BT. However, the ambient device 108 in this embodiment either does not have a battery or has a battery (e.g., a coil cell battery) that has less battery storage than a conventional Wi-Fi and/or BT device, thereby limiting the Wi-Fi and/or BT device's communication range to within a maximum range of 10-20 meters, which is less than the maximum range of a conventional Wi-Fi/BT device.

As another example, the ambient device 108 may be a sensor device, such as a temperature sensor that measures and records temperate data, a pressure sensor that measures and records pressure data, and/or any other type of sensor device. The sensor may communicate (e.g., send, provide, report) the recorded data back to the reading device 106 by using the second type of communication protocol.

The ADM system 101 and/or an administrator of the ADM system 101 may generate a unique device identifier for an ambient device 108 so to indicate the particular ADM server 104 that can directly or indirectly communicate with the ambient device. For example, the ADM system 101 may determine that the ADM server 104 can communicate with the ambient device 108 by communication through the reading device 106. Therefore, the ADM system 101 may define the device identifier for the ambient device 108 as a string that has a prefix matching the network address (e.g., Uniform Resource Locator (URL)) of the ADM server 104.

The reading device 106 may be any type of a device that has the capability (e.g., hardware, software, etc.) to communicate across the communication network 120 using the first type of communication protocol and communicate with the ambient device 108 using the second type of communication protocol. For example, the reading device 106 may be a smart phone, a laptop, a desktop, a game console, a set-top box (STB), a cloud device (e.g., a host machine), test equipment. The reading device 106 may be a conventional Wi-Fi device (e.g., a device with normal power consumption and bit rate because it has its own sufficiently-large battery or is powered by an external power source), such as a Wi-Fi access point device.

The user device 102 and the ADM server 104 are each unable to communicate with the ambient device 108 for several reasons. In some embodiments, the user device 102 and the ADM server 104 lack the hardware and/or software to send/receive messages using the first type of communication protocol. In some embodiments, the user device 102 and the ADM server 104 may be equipped with the hardware and/or software to send/receive messages using the second type of communication protocol, but they are physically located outside of the maximum range of the second type of communication protocol.

The ADM system 101 includes a Server/Reading Device/Ambient Device (S/RD/AD) mapping data store 130 for storing a plurality of S/RD/AD mappings. The S/RD/AD mapping data store 130 may be a database, a flat file, memory, and/or the like. Each S/RD/AD mapping indicates an association (e.g., a link) between (1) an identifier of the ADM server 104, (2) an identifier of a particular ambient device 108 that is communicatively coupled to the ADM server 104 via the first type of communication protocol, and (3) the identifiers of the reading devices 106 that are within the maximum distance for the particular ambient device 108 to be able to communicate with the reading devices 106 via the second type of communication protocol. For example, the S/RD/AD mapping data store 130 in FIG. 1 shows a first mapping that links the identifier (S_ID) of the ADM server 104 with the identifier (RD_ID 1) of a first reading device 106 and an identifier (AD_ID 1) of the ambient device 108; and a second mapping that links the identifier (S_ID) of the ADM server 104 with the identifier (RD_ID 2) of a second reading device 106 and an identifier (AD_ID 2) of the ambient device 108. However, the S/RD/AD mapping data store 130 in FIG. 1 does not include an S/RD/AD mapping that links the reading device 106 to the ambient device 112 because the ambient device 112 is outside of the range to be able to communicate with the reading device 106.

The reading device 106 and the ambient device 108 indicated by an item of mapping data were not previously connected via the second type of communication protocol (e.g., communication protocol B), but the ADM server 104 linked their respective identifiers to form the item of mapping data because the ADM server 104 determined that these devices are physically close enough to one another to establish this type of connection. However, in other embodiments, the ADM server 104 only links the reading device 106 and the ambient device 108 in sets of mapping data if these devices were previously connected via the second type of communication protocol.

The ADM server 104 may populate the S/RD/AD mapping data store 130 with S/RD/AD mappings by sending messages to the reading device 106 to cause the reading device 106 to discover the ambient device 108 that is within the limited distance of the reading device 106 to facilitate communication using the second type of communication protocol, and then report back the results to the ADM system 101.

The ADM server 104 may use the mappings in the S/RD/AD mapping data store 130 to determine which reading device 106 is capable of accessing the ambient device 108 that is indicated in the data request from the user device 102. For example, the user device 102 may send a data request to the ADM server 104 to request for data associated (e.g., generated by) with an ambient device 108 associated with a first identifier (AD_ID_1). The ADM server 104 may check the mappings in the S/RD/AD mapping data store 130 to determine that reading device 106 is capable (e.g., physically proximate to and/or and able to establish a connection via the second communication protocol) of communicating with the ambient device 108 associated with a first identifier (AD_ID_1).

The ADM server 104 may provide the user device 102 with access to the S/RD/AD mapping data store 130 so that the user device 102 may determine which ADM server 104 should be accessed to gain access to the data of a particular ambient device 108. For example, the user device 102 may want to access the data associated with an ambient device 108 associated with a first identifier (AD_ID_1). The user device 102 may check the mappings in the S/RD/AD mapping data store 130 to determine that the ADM server 104 can access the ambient device 108 through reading device 106. In response, the user device 102 may decide to send its data request to the ADM server 104 instead of any other ADM servers that might exist in the ADM system 101 because the mappings indicate that the other ADM servers do not have the capability to access the data on the ambient device 108.

Although FIG. 1 shows that the ADM system 101 only includes a select number of computing devices (e.g., ADM servers 104, user device 101, reading device 106, ambient device 108, ambient device 108, firewall 110) and private networks, the ADM system 101 may include any number of computing devices and private networks that are interconnected in any arrangement to facilitate the exchange of data between the computing devices. For example, ADM server 104 may be coupled to a second firewall, which creates a second private network around a group of reading devices and a group of ambient devices. Some ambient devices are physically close enough to some of the reading devices to be able to communicate with the reading devices using communication protocol B, while other ambient devices are physically too far from some of the reading devices to be able communicate with the reading devices using communication protocol B.

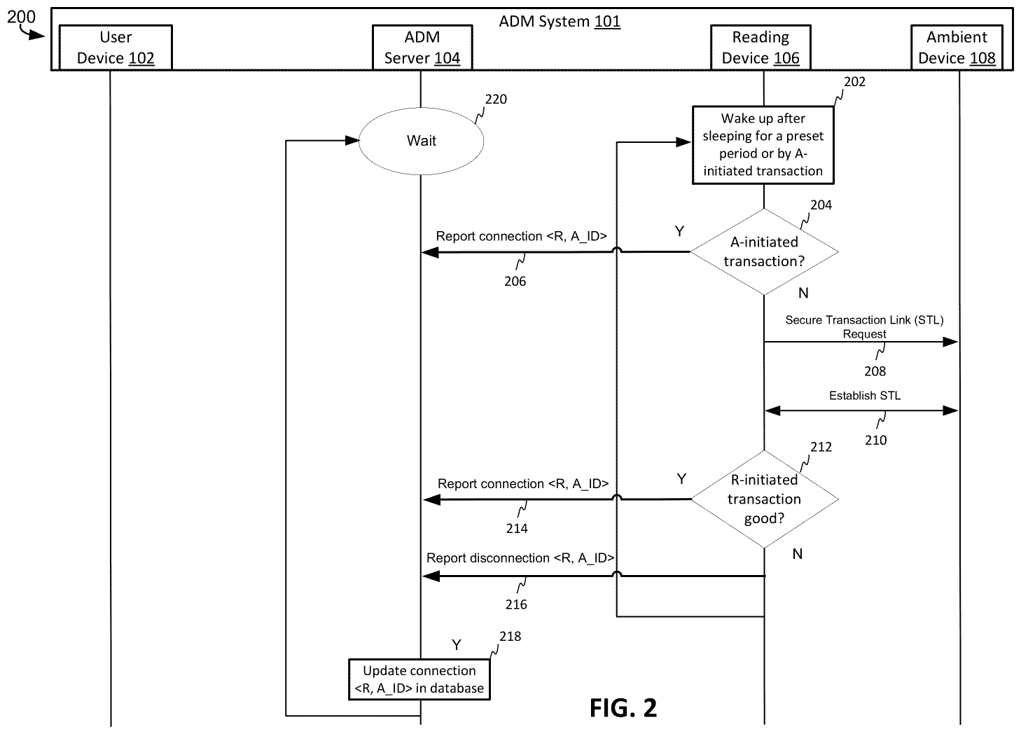

FIG. 2 illustrates a flowchart for populating a data store with mapping data that indicates an association between ADM servers, reading devices, and ambient devices and to be used for performing remote transactions with the ambient devices, according to some embodiments. Specifically, the flowchart 200 shows the signals and operations of several devices (e.g., ADM server 104, the reading device 106, and the ambient device 108). The devices perform the operations shown in the flowchart 200, so that the ADM server 104 can generate sets of mapping data and store the mapping data in a data store (e.g., S/RD/AD mapping data store 130). The mapping data indicates the groups of ambient devices that are in short communication range with reading devices via the second type of communication protocol.

As discussed in greater detail below, the reading device 106 periodically (the period may be configurable) verifies the ambient device 108 is in range and reports to the ADM server 104 whether it can communicate with the ambient device 108. The reading device 106 may skip the verification if it has recently accessed (e.g., within the past 5 minutes) the ambient device 108 for providing remote access for some user devices, or it has recently received (e.g., within the past 5 minutes) a transaction that was initiated by the ambient device 108. The ADM server 104 saves the connection information (e.g., the IP address of the reading device, the ID of the ambient device 108) into the S/RD/AD Mapping Data Store 130 if the reading device 106 can reach the ambient device 108 via the chosen protocol, otherwise the ADM server 104 removes the connection from its data store if the ambient device 108 has not been accessible by the reading device 106 for a period longer than a preset threshold.

At operation 202, the reading device 106 wakes up after sleeping for a preset period or by the ambient device 108 (referred to as “A” in FIG. 2) initiating a transaction.

At operation 204, the reading device 106 (referred to as “R” in FIG. 2) determine whether the ambient device initiated a transaction with the reading device 106. If yes, then the reading device 106 proceeds to operation 206 to send a reporting message to the ADM server 104 to indicate a connection between the reading device 106 and the ambient device 108, where the reporting message includes the IDs of both devices. If no, the reading device 106 proceeds to operation 208 to initiate a secure transaction with the ambient device 108 as a test. If the transaction succeeds at operation 210, then the reading device 106 sends a reporting message to the ADM server 104 to indicate that the reading device 106 can communicate with the ambient device 108.

The reading device 106 and the ambient device 108 may communicate via an STL (e.g., a secure communication link, a secure communication session) according to a conventional STL procedure or an enhanced STL procedure. According to the enhanced STL procedure, the reading device 106 and the ambient device 108 perform a mutual authentication (e.g., a bi-directional authentication), which is where each device verifies each other's identity instead of only a single device verifying the other device's identify. The two devices then generate one or more encryption keys and use the one or more encryption keys to encrypt/decrypt their communication between one another. For example, one large-size key is generated from two sets of authentication parameters (e.g., one set generated by the reading device 106 and one set generated by the ambient device 108). The key is then split into 3 or 4 portions depending on whether the optional Institute of Electrical Electronics Engineers (IEEE) 802.11ax PHY security feature is supported. One portion may be used for unicast data encryption. One portion may be used for Message Integrity Code (MIC) in 4-way handshake. One portion maybe used for encrypting group keys sent by access point (AP) to station (STA). If the optional IEEE 802.11az PHY security feature is supported, one portion is used to generate IEEE 802.11ax PHY LTF symbols for secure IEEE 802.11az ranging.

Notably, the ambient device 108 and the reading device 106 each consume less power to communicate via an STL when using the enhanced STL procedure because the enhanced STL procedure (sometimes referred to as a compact secure transaction model) involves the exchange of a fewer number of frames (e.g., 3-4 frames) as compared to the conventional STL procedure (e.g., 10 frames).

At operation 212, the reading device 106 determines whether the connection/transaction that was initiated by the reading device 106 is good (e.g., sufficient quality, etc.). If yes, then the reading device 106 proceeds to operation 214 to send a reporting message to the ADM server 104 to indicate a connection between the reading device 106 and the ambient device 108, where the reporting message includes the IDs of both devices. If no, the reading device 106 proceeds to operation 216 to send a reporting message to the ADM server 104 to indicate that there is a disconnection between the reading device 106 and the ambient device 108, where the reporting message includes the IDs of both devices.

At operation 218, the ADM server 104 updates the mapping data in the S/RD/AD mapping data store 130 to indicate any connections and/or disconnections between the reading device 106 and the ambient device 108.

The ADM server 104 proceeds to operation 220 to wait for the next report connection (e.g., 206, 214, 216) from the reading device 106.

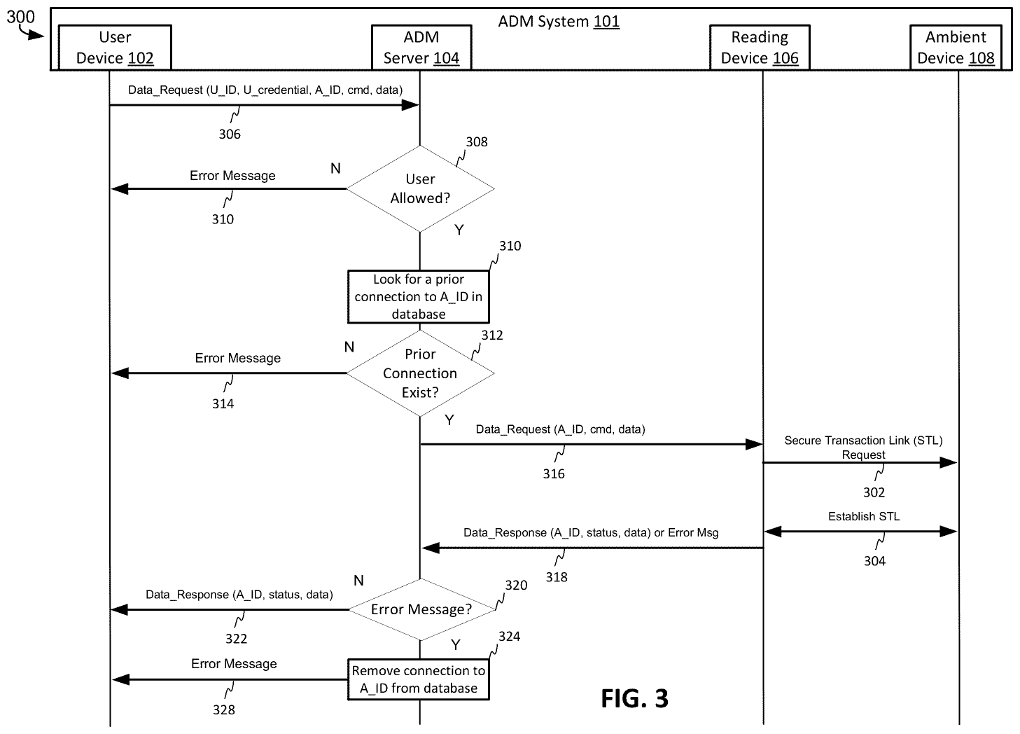

FIG. 3 illustrates a flowchart for the ADM system 101 in FIG. 1 where reading devices initiate STLs with ambient devices, according to some embodiments. Specifically, the flowchart 300 shows the signals and operations of the user device 102, the ADM server 104, the reading device 106, and the ambient device 108.

At operation 302, the reading device 106 initiates an STL (e.g., a secure communication link, a secure communication session) with the ambient device 108 by sending a connection request to the ambient device 108 to form the STL, which prompts the two devices to exchange frames and establish the STL at operation 304.

At operation 306, the user device 102 sends a data request to the ADM server 104 to request for the ADM server 104 to provide the user device 102 with access to the data that is generated by the ambient device 108. The user device 102 selected the ADM server 104 from a plurality of ADM servers by determining, based on the mapping data stored in the S/RD/AD mapping data store 130, that reading device 106 is capable of communicating with the ambient device 108 using the second type of communication protocol and that the ADM server 104 is capable of communicating with the reading device 106 using the first type of communication protocol. The data request may include the identifier (e.g., U_ID) of the user device 102, the credentials (e.g., access rights, a pair of user name and password, etc.) of the user device 102, the identifier (e.g., A_ID) of the ambient device 108 that generates the data in which the user device 102 is seeking to access, a command, and data.

At operation 308, the ADM server 104 determines whether the user device 102 has the requisite permission (e.g., from the ambient device 108 and/or the reading device 106) to access the data generated by the ambient device 108. If no permission, then the ADM server 104 proceeds to operation 310 and sends an error message to the user device 102, where the error message indicates that the user device 102 does not have the requisite permission to access the data.

Otherwise, if the user device 102 does have permission, then the ADM server 104 proceeds to operation 310 to check the mapping data stored in the S/RD/AD mapping data store 130 and operation 312 to determine whether, based on the mapping data, whether there was a prior connection of the second type of communication protocol between any of the reading devices 106 in the private network 122 and the ambient device 108. If there were no prior connections, based on the mapping data, then the ADM server 104 proceeds to operation 314 and sends an error message to the user device 102, where the error message indicates that there are no reading devices (such as reading device 106) that are capable of connecting with the ambient device 108 to retrieve the data.

However, if the ADM server 104 determines, based on the mapping data, there was a previous connection of the second type of communication protocol between a particular reading device 106 and the ambient device 108, then the ADM server proceeds to operation 316 to send a data request to the reading device 106, where the data request includes the identifier (A_ID) of the ambient device 108, a command, and data.

In some embodiments, the ADM server 104 may include commands in the data request, which the reading device 106 may send to the ambient device 108 to process. For example, the ambient device 108 may be a thermostat that can be controlled (e.g., increase or decrease the temperature) via the commands.

At operation 318, the ADM server 104 may receive either a data response or an error message from the reading device 106. If there are no connection issues between the devices (e.g., ADM server 104 to reading device 106 to ambient device 108), then the ADM server receives a data response that includes the requested data and/or a status flag indicating the quality (e.g., reliable/unreliable data, incomplete/complete data, uncorrupted/corrupted data) of the data or whether the requested data is not available. However, if there are connection issues between the devices, then the ADM server receives an error message indicating the type of connection issues.

At operation 320, the ADM server 104 determines whether the ADM server 104 received an error message or a data response from the reading device 106. If the ADM server 104 received a data response, then the ADM server 104 proceeds to operation 322 to send/forward the data response to the user device 102.

However, if the ADM server 104 received an error message, then the ADM server 104 proceeds to operation 324 to update the mapping data stored in the S/RD/AD mapping data store 130 to indicate that it is not possible for these devices (e.g., ADM server 104, reading device 106, and/or ambient device 108) to reliably communicate. For example, the ADM server 104 can update the mapping data by removing this information about this connection from the mapping data.

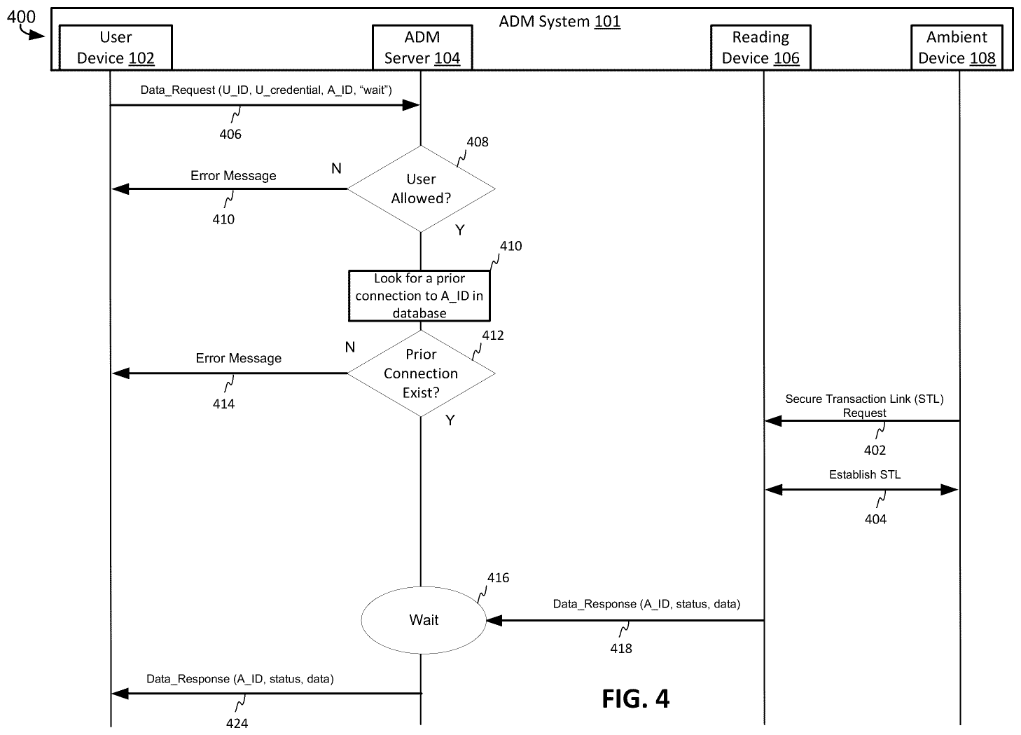

FIG. 4 illustrates a flowchart for the ADM system 101 in FIG. 1 where ambient devices initiate STLs with reading devices, according to some embodiments. Specifically, the flowchart 400 shows the signals and operations of the user device 102, the ADM server 104, the reading device 106, and the ambient device 108.

At operation 402, the ambient device 108 initiates an STL (e.g., secure communication link, secure communication session) with the reading device 106 by sending a connection request to the reading device 106 to form the STL, which prompts the two devices to exchange frames and establish the STL at operation 404.

At operations 405, the user device 102 selects the ADM server 104 from a plurality of ADM servers by determining, based on the mapping data stored in the S/RD/AD mapping data store 130, that reading device 106 is capable of communicating with the ambient device 108 using the second type of communication protocol and that the ADM server 104 is capable of communicating with the reading device 106 using the first type of communication protocol. The data request may include the identifier (e.g., U_ID) of the user device 102, the credentials (e.g., access rights, a pair of user name and password, etc.) of the user device 102, the identifier (e.g., A_ID) of the ambient device 108 that generates the data in which the user device 102 is seeking to access, a command, and data.

At operation 406, the user device 102 sends a data request to the ADM server 104 to request for the ADM server 104 to provide the user device 102 with access to the data that is generated by the ambient device 108.

At operation 408, the ADM server 104 determines whether the user device 102 has the requisite permission (e.g., from the ambient device 108 and/or the reading device 106) to access the data generated by the ambient device 108. If no permission, then the ADM server 104 proceeds to operation 410 and sends an error message to the user device 102, where the error message indicates that the user device 102 does not have the requisite permission to access the data.

If the user device 102 does have permission at operation 408, then the ADM server 104 proceeds to operation 410 to check the mapping data stored in the S/RD/AD mapping data store 130 and operation 412 to determine, based on the mapping data, whether there was a prior connection of the second type of communication protocol between any of the reading devices 106 in the private network 122 and the ambient device 108. If there were no prior connections, based on the mapping data, then the ADM server 104 proceeds to operation 414 and sends an error message to the user device 102, where the error message indicates that there are no reading device 106 that are capable of connecting with the ambient device 108 to retrieve the data.

However, if the ADM server 104 determines, based on the mapping data, there was a prior connection of the second type of communication protocol between a particular reading device 106 and the ambient device 108, then the ADM server proceeds to operation 416 to wait to receive the data from the ambient device 108 via the second type of communication protocol.

At operation 418, the ADM server 104 receives a data response from the reading device 106, where the data response includes the requested data and/or a status flag indicating the quality (e.g., reliable/unreliable data, incomplete/complete data, uncorrupted/corrupted data) of the data or whether the requested data is not available.

At operation 424, the ADM server 104 sends/forwards the data response to the user device 102.

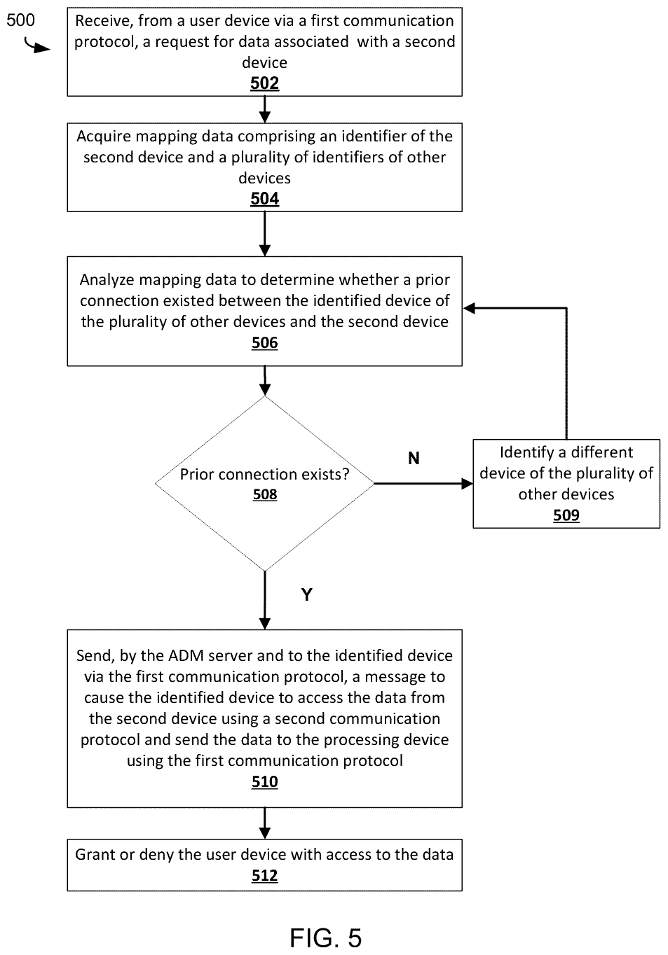

FIG. 5 is a flow diagram of a procedure for performing remote transactions using multiple types of radio frequency (RF) communication protocols, according to some embodiments. Although the operations are depicted in FIG. 5 as integral operations in a particular order for purposes of illustration, in other implementations, one or more operations, or portions thereof, are performed in a different order, or overlapping in time, in series or parallel, or are omitted, or one or more additional operations are added, or the method is changed in some combination of ways. In some embodiments, the procedure 500 may be performed by processing logic that includes hardware (e.g., circuitry, dedicated logic, programmable logic, microcode, etc.), firmware, or a combination thereof. In some embodiments, some or all operations of procedure 500 may be performed by one or more components (e.g., user device 102, ADM server 104, reading device 106, ambient device 108, etc.) of the ADM system in FIG. 1.

At operation 502, in some embodiments, the ADM server 104 receives, from the user device 102 via a first communication protocol, a request for data associated with a second device (e.g., ambient device 108). At operation 504, in some embodiments, the ADM server 104 acquires mapping data comprising an identifier of the second device and a plurality of identifiers of other devices. At operation 506, in some embodiments, the ADM server 104 analyzes (e.g., inspects) the mapping data to determine whether there was a prior connection between the identified device of the plurality of other devices and the second device. At operation 508, if there were no prior connections between the devices, then the ADM server 104 proceeds to operation 509 to identify a different device of the plurality of other devices, and then proceeds to operation 506.

If there was a prior connection, then the ADM server 104 proceeds to operation 510 to send, to the identified device via the first communication protocol, a message to cause the identified device to access the data from the second device using a second communication protocol and send the data to the ADM server 104 using the first communication protocol. The ADM server 104 then proceeds to operation 512 to grant or deny the user device 102 with access to the data.

In some embodiments, the ADM server 104 grants or denies the user device 102 access to the data by determining whether the user device 102 has permission to access the data associated with the second device, and either sends the data to the user device 102 responsive to determining that the user device 102 has the permission to access the data, or sends an error message to the user device 102 responsive to determining that the user device 102 does not have the permission to access the data. In some embodiments, the error message indicates that the user device 102 does not have the permission to access the data.

In some embodiments, the ADM server 104 generates mapping data including a first group of identifiers to devices of a first type and a second group of identifiers to devices of a second type, and stores the mapping data in a data store (e.g., S/RD/AD mapping data store 130). In some embodiments, the devices of the second group of identifiers are incapable of communicating using the first communication. In some embodiments, the devices of the first type are each configured to communicate using multiple types of RF communication protocols and the device of the second type are each configured to communicate using only a single type of RF communication protocol.

In some embodiments, the ADM server 104 determines, based on the request, the capability of the first device to access the second device by identifying the first device based on the mapping data.

In some embodiments, the ADM server 104 determines the capability of the first device to access the second device by determining, based on the mapping data, an existence of a prior connection between the first device and the second device, where the prior connection was of the second communication protocol. In some embodiments, the ADM server 104 determines the capability of the first device to access the second device by determining, based on the mapping data, that a physical location of the first device relative to a physical location of the second device is within a maximum range to communicate via the second communication protocol.

In some embodiments, the second device initiated the prior connection with the first device. In some embodiments, the first device initiated the prior connection with the second device.

In some embodiments, the ADM server 104 determines that the prior connection between the first device and the second device no longer exists; and updates the mapping data to indicate that the prior connection between the first device and the second device no longer exists. In some embodiments, the ADM server 104 the prior connection was established via a mutual authentication procedure performed by the first device and the second device. In some embodiments, the first communication protocol is Wi-Fi and the second communication protocol is near field communication (NFC).

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “sending,” “granting,” “denying,” “generating,” “storing,” “updating,” or the like, refer to the actions and processes of an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as an AC-DC converter, and/or an ESD protection system/circuit) for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The above description sets forth numerous specific details such as examples of specific systems, components, methods, and so forth, in order to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, from a user device via first communication protocol, a request for data associated with a second device;
determining, based on the request, a capability of a first device to access the data from the second device via a second communication protocol;
sending, by one or more processors to the first device via the first communication protocol, a message to cause the first device to access the data from the second device using the second communication protocol and send the data to the one or more processors using the first communication protocol; and
granting or denying the user device with access to the data.

2. The method of claim 1, wherein granting or denying the user device with the access to the data further comprises:
determining whether the user device has permission to access the data associated with the second device, and either:
sending the data to the user device responsive to determining that the user device has the permission to access the data, or
sending an error message to the user device responsive to determining that the user device does not have the permission to access the data, wherein the error message indicates that the user device does not have the permission to access the data.

3. The method of claim 1, further comprising:
generating mapping data comprising a first group of identifiers to devices of a first type and a second group of identifiers to devices of a second type, wherein the devices of the second group of identifiers are incapable of communicating using the first communication protocol; and
storing the mapping data in a data store.

4. The method of claim 3, wherein determining, based on the request, the capability of the first device to access the second device comprises:
identifying the first device based on the mapping data.

5. The method of claim 3, wherein determining, based on the request, the capability of the first device to access the second device comprises at least one of:
determining, based on the mapping data, an existence of a prior connection between the first device and the second device, wherein the prior connection was of the second communication protocol, or
determining, based on the mapping data, that a physical location of the first device relative to a physical location of the second device is within a maximum range to communicate via the second communication protocol.

6. The method of claim 5, wherein the second device initiated the prior connection with the first device.

7. The method of claim 5, wherein the first device initiated the prior connection with the second device.

8. The method of claim 5, further comprising:
determining that the prior connection between the first device and the second device no longer exists; and
updating the mapping data to indicate that the prior connection between the first device and the second device no longer exists.

9. The method of claim 5, wherein the prior connection was established via a mutual authentication procedure performed by the first device and the second device.

10. The method of claim 1, wherein the first communication protocol is Wi-Fi and the second communication protocol is near field communication (NFC).

11. An ambient device management (ADM) system, comprising:
a first device;
one or more processors communicatively coupled to the first device via a first communication protocol, the one or more processors configured to:
receive, from a user device via the first communication protocol, a request for data associated with a second device;
determine, based on the request, a capability of the first device to access the data from the second device;
send, to the first device via the first communication protocol, a message to cause the first device to access the data from the second device using a second communication protocol and send the data to the one or more processors using the first communication protocol; and
grant or deny the user device with access to the data.

12. The ADM system of claim 11, wherein to grant or deny the user device with the access to the data, the one or more processors is further configured to:
determine whether the user device has permission to access the data associated with the second device, and either:
send the data to the user device responsive to determining that the user device has the permission to access the data, or
send an error message to the user device responsive to determining that the user device does not have the permission to access the data, wherein the error message indicates that the user device does not have the permission to access the data.

13. The ADM system of claim 11, wherein the one or more processors is further configured to:
generate mapping data comprising a first group of identifiers to devices of a first type and a second group of identifiers to devices of a second type, wherein the devices of the second group of identifiers are incapable of communicating using the first communication protocol; and
store the mapping data in a data store.

14. The ADM system of claim 13, wherein to determine, based on the request, the capability of the first device to access the second device, the one or more processors is further configured to:
identify the first device based on the mapping data.

15. The ADM system of claim 13, wherein to determine, based on the request, the capability of the first device to access the second device, the one or more processors are to:
determine, based on the mapping data, an existence of a prior connection between the first device and the second device, wherein the prior connection was of the second communication protocol, or
determine, based on the mapping data, that a physical location of the first device relative to a physical location of the second device is within a maximum range to communicate via the second communication protocol.

16. The ADM system of claim 15, wherein the second device initiated the prior connection with the first device.

17. The ADM system of claim 15, wherein the first device initiated the prior connection with the second device.

18. The ADM system of claim 15, where the one or more processors are to further configured to:
determine that the prior connection between the first device and the second device no longer exists; and
update the mapping data to indicate that the prior connection between the first device and the second device no longer exists.

19. The ADM system of claim 15, wherein at least one of:
the prior connection was established via a mutual authentication procedure performed by the first device and the second device, or
the first communication protocol is Wi-Fi and the second communication protocol is near field communication (NFC).

20. A method comprising:
monitoring, via a first communication protocol, a plurality of devices of a first type to determine a plurality of connection states between the plurality of devices of the first type and a plurality of devices of a second type, the connection states indicative of connections of a second communication protocol;
selecting, by one or more processors and based on the plurality of connection states, a first device of the plurality of devices of the first type and a second device of the plurality of devices of the second type; and
accessing data of the second device via the first device.
